(19) United States
(12) Patent Application Publication
(10) Pub. No.: US 2018/0120642 A1
(43) Pub. Date: May 3, 2018

(54) METHOD AND DEVICE FOR DRIVING A BACKLIGHT SOURCE

(71) Applicant: Qingdao Hisense Electronics Co., Ltd., Shandong (CN)

(72) Inventor: Yuxin ZHANG, Shandong (CN)

(21) Appl. No.: 15/858,074

(22) Filed: Dec. 29, 2017

(30) Foreign Application Priority Data
Sep. 20, 2017 (CN) 201710854545.2

(51) Int. Cl. G02F 1/1335; G09G 3/18

(52) U.S. Cl. CPC G02F 1/133611; G09G 2310/0264; G09G 3/18

(57) ABSTRACT

The present application discloses a method and device for driving a backlight source, and belongs to the field of display technologies. The method includes: determining a current amplitude of a PWM control signal for controlling a brightness of the backlight source according to the maximum brightness parameter value of pixels in an input image frame; generating the PWM control signal for controlling the brightness of the backlight source according to the current amplitude of the PWM control signal and a predetermined duty ratio of the PWM control signal; and driving the backlight source to emit light according to the generated PWM control signal.

### CROSS-REFERENCE TO RELATED APPLICATION

The present application claims the benefit and priority of Chinese Patent Application No. 201710854545.2 filed Sep. 20, 2017. The entire disclosure of the above application is incorporated herein by reference.

### FIELD

The present disclosure relates to the field of display technologies and particularly to a method and device for driving a backlight source.

### BACKGROUND

This section provides background information related to the present disclosure which is not necessarily prior art.

At present, the High-Dynamic Range (HDR) video image has become a mainstream in the industry. The HDR video image has a higher tolerance and a wider brightness range, and may also present more highlight details under the condition of high light ratio. Thus compared with the ordinary video, the HDR video has better picture layering and depth of field, and may show the scene more realistically.

For the image frame with a larger brightness range and a higher contrast ratio, the display effect of the related products still needs to be further improved.

### SUMMARY

This section provides a general summary of the disclosure, and is not a comprehensive disclosure of its full scope or all of its features.

In a first aspect, embodiments of the present application provide a method for driving a backlight source, where the method includes:

determining a current amplitude of a Pulse Width Modulation (PWM) control signal for controlling a brightness of the backlight source according to a maximum brightness parameter value of pixels in an input image frame;

generating the PWM control signal for controlling the brightness of the backlight source according to the current amplitude of the PWM control signal and a predetermined duty ratio of the PWM control signal; and

driving the backlight source to emit light according to the generated PWM control signal.

In a second aspect, embodiments of the present application provide a method for driving a backlight source, where the method includes:

determining a current amplitude of a Pulse Width Modulation, PWM, control signal for controlling a backlight partition corresponding to an image partition in an input image frame according to a maximum brightness parameter value of pixels in the image partition, where there is a one-to-one correspondence between the image partition and the backlight partition;

generating the PWM control signal of the backlight partition according to the current amplitude of the PWM control signal of the backlight partition and a predetermined duty ratio of the PWM control signal of the backlight partition; and

driving a backlight source of the backlight partition to emit light according to the PWM control signal of the backlight partition.

In a third aspect, embodiments of the present application provide a liquid crystal display terminal, where the terminal includes a backlight source, a display panel, a non-transitory storage medium and at least one processor; the non-transitory storage medium stores preset computer program codes, and the processor is configured to read the preset computer program codes in the non-transitory storage medium to perform:

determining a current amplitude of a PWM control signal for controlling a brightness of the backlight source according to a maximum brightness parameter value of pixels in an input image frame;

generating the PWM control signal for controlling the brightness of the backlight source according to the current amplitude of the PWM control signal and a predetermined duty ratio of the PWM control signal; and

driving the backlight source to emit light according to the generated PWM control signal.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart of a method for driving a backlight source provided by some embodiments of the present application.

FIG. 2 is a flow chart of another method for driving a backlight source provided by some embodiments of the present application.

FIG. 3 is a schematic diagram of a process of generating a PWM control signal provided by some embodiments of the present application.

FIG. 4 is a flow chart of another method for driving a backlight source provided by some embodiments of the present application.

FIG. 5 is a schematic diagram of another process of generating a PWM control signal provided by some embodiments of the present application.

FIG. 6 is a flow chart of another method for driving a backlight source provided by some embodiments of the present application.

FIG. 7 is a schematic diagram of another process of generating a PWM control signal provided by some embodiments of the present application.

FIG. 8 is a flow chart of another method for driving a backlight source provided by some embodiments of the present application.

FIG. 9A is a schematic diagram of a first way for dividing a backlight region provided by some embodiments of the present application.

FIG. 9B is a schematic diagram of a second way for dividing a backlight region provided by some embodiments of the present application.

FIG. 10 is a structure schematic diagram of a device for driving a backlight source provided by some embodiments of the present application.

FIG. 11 is a structure schematic diagram of another device for driving a backlight source provided by some embodiments of the present application.

FIG. 12 is a structure schematic diagram of another device for driving a backlight source provided by some embodiments of the present application.

FIG. 13 is a structure schematic diagram of another device for driving a backlight source provided by some embodiments of the present application.

FIG. 14 is a structure schematic diagram of another device for driving a backlight source provided by some embodiments of the present application.

FIG. 15 is a structure diagram of a liquid crystal display terminal provided by some embodiments of the present application.

Corresponding reference numerals indicate corresponding parts or features throughout the several views of the drawings.

### DETAILED DESCRIPTION

Example embodiments will now be described more fully with reference to the accompanying drawings.

For the image frame with the larger brightness range and the higher contrast ratio, there may be the scene where a small area is highlighted in the overall darker picture, for example, a very bright moon in the dark night. For such a video image with the larger brightness range, the display effect of the related products still needs to be further improved.

The present application uses the PWM technology to control the backlight source to emit light, i.e., achieve the switching between the on-state with 100% brightness and the off-state with 0% brightness on the basis of the backlight current by controlling the times of switching on and off of the backlight source. The PWM enables the backlight source to operate in its on-state by controlling the repetition time period at a certain percent. When the time period is sufficiently short (e.g., 1 millisecond), the human vision system fails to detect the cycle between the on-state and the off-state of the backlight source, and the observer perceives the average emitted light intensity which is proportional to the percent of the PWM control time period during which the backlight source is in on-state, where this percent is called a duty ratio of the PWM signal. For example, the light emitter driven by the PWM control signal with the duty ratio of 75% is switched on in 75% of each PWM time period, and the light with 75% of its maximum brightness which is emitted stably likely is presented to the observer.

Thus determining the current amplitude and the duty ratio of the PWM control signal is the key to driving the backlight source to emit light. With the ordinary backlight drive method of videos in the related art, exemplarily, under the scene where a small area is highlighted in the overall darker picture in the video image, because the duty ratio of the control signal is determined according to the grayscale mean value which is obviously very low and the current amplitude of the PWM control signal is a preset value, the backlight brightness corresponding to the highlighted portion may be relatively low, that is, the backlight brightness of the scene with the small highlighted area cannot be increased, thereby influencing the display effect of the videos. The methods for driving the backlight source provided by the present application may aim at the HDR video and the operations of the method are as follows.

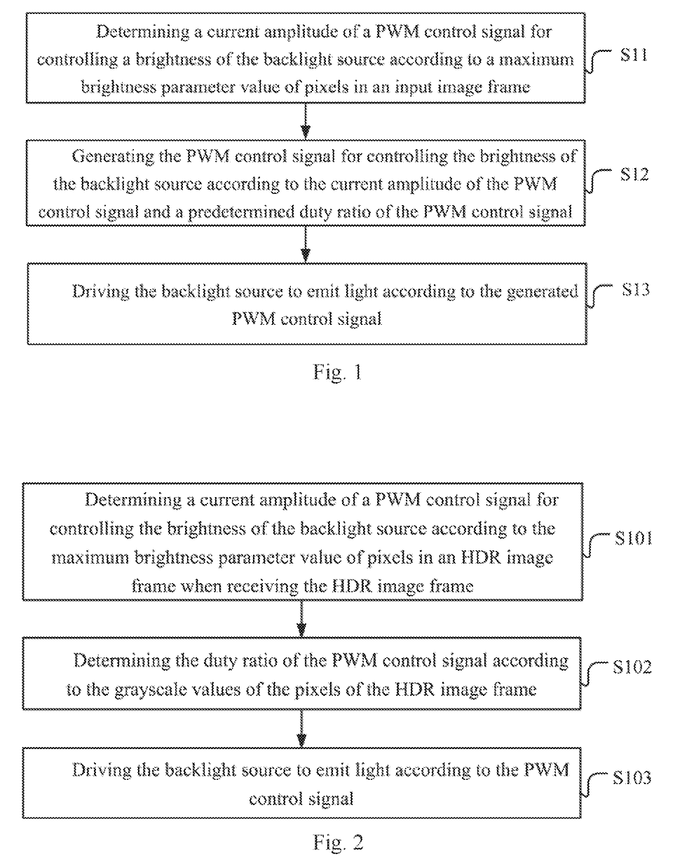

FIG. 1 is a flow chart of a method for driving a backlight source provided by some embodiments of the present application. As shown in FIG. 1, this method includes the following operations.

Operation S11: determining a current amplitude of a PWM control signal for controlling a brightness of the backlight source according to a maximum brightness parameter value of pixels in an input image frame.

Operation S12: generating the PWM control signal for controlling the brightness of the backlight source according to the current amplitude of the PWM control signal and a predetermined duty ratio of the PWM control signal.

Operation S13: driving the backlight source to emit light according to the generated PWM control signal.

In some embodiments, the above-mentioned input image frame may be an HDR image frame, and of course may also be other types of image frame, which is not limited herein.

The above-mentioned PWM control signal may be output from a chip. Since the chip outputs level signals and the low level of the PWM control signal is 0 in some embodiments, the current amplitude of the above-mentioned PWM control signal may be interpreted as the corresponding value when the level signal is at the high level. In some embodiments, the low level of the PWM control signal may not be 0, and the current amplitude of the PWM control signal refers to the amplitude difference between the high-level state and the low-level state of the generated PWM control signal.

In some embodiments, the approach of determining the current amplitude of the PWM control signal for controlling the brightness of the backlight source in the operation S11 may depend on the maximum brightness parameter value of the pixels in the image frame; and may also depend on the maximum brightness parameter value of the pixels in the image frame and the grayscale values of the pixels in the image frame.

In some embodiments, the predetermined duty ratio of the PWM control signal in the operation S12 may be determined according to the grayscale values of the pixels in the image frame; or may be determined according to the grayscale values of the pixels in the image frame and the current amplitude of the PWM control signal; or may be a preset fixed value.

In some embodiments, driving the backlight source to emit light according to the PWM control signal may be implemented as follows: if the time period, during which a working current value of the backlight source is between a rated current value and a maximum current value of the backlight source, exceeds a threshold, then adjusting the current amplitude of the PWM control signal to be a current amplitude corresponding to the rated current value of the backlight source.

In the embodiments of the present application, the current amplitude of the PWM control signal is determined according to the maximum brightness parameter value of the pixels in the input image frame, so that the backlight brightness peak of the backlight source may be controlled by the PWM drive signal to match with the maximum brightness of the pixels of the image frame, which may solve the problem that the backlight brightness of the image with a small highlighted area cannot be increased by the related backlight driving method and further improve the image quality effect.

The solutions of the present application will be described below in details in combination with embodiments. In the following embodiments, an HDR video image is taken as an example to illustrate, that is, the input image frame is an HDR image frame. It should be understood that the methods for driving the backlight source provided by the embodiments of the present application are not limited to the HDR video image, and the drive control of the backlight source may also be performed for other types of video image.

FIG. 2 is a flow chart of a method for driving a backlight source provided by some embodiments of the present application. As shown in FIG. 2, this method includes the following operations.

Operation S101: determining a current amplitude of a PWM control signal for controlling the brightness of the backlight source according to the maximum brightness parameter value of pixels in an HDR image frame when receiving the HDR image frame.

The method for driving the backlight source provided by some embodiments of the present application may aim at the HDR video. The mainstream standards of the HDR video include HDR10, Dolby Vision, Technicolor/Philips HDR, BBC HDR and the like. Generally the operators of movies and streaming media mostly support the Dolby Vision and the HDR10, while the television stations such as BBC and NHK choose the Technicolor/Philips HDR and the BBC HDR. The metadata recording the production information is generated in the process of producing the HDR video, and the metadata and the image data are transmitted as a whole, where the metadata generally includes the Maximum Content Light Level (MaxCLL), the Maximum Frame-average Light Level (MaxFALL) and other parameters, and the image data includes the image content of all the pixels. In the embodiments of the present application, the Maximum Content Light Level (i.e., the maximum brightness parameter value of the pixels) in the metadata of the HDR image frame is used to determine the current amplitude of the PWM control signal.

For example, the HDR video signal is parsed to obtain the encoded data of each frame of HDR image. The encoded data includes the image data and the metadata, where the metadata includes the maximum brightness parameter value of the pixels in the HDR image frame, so that the pixel grayscale values and the maximum brightness value of the HDR image frame are obtained.

In some embodiments, the storage forms of the metadata and the image data are not limited in the present application. The metadata and the image data may be stored in form of record chart, record strip or the like, and the metadata and the image data may be stored separately, where the metadata of the whole video image frame are stored and distinguished by labels, and the metadata and the image data of each frame of video image may also be stored as a whole by taking the video image frame as unit.

In some embodiments, the current amplitude of the PWM control signal corresponding to the maximum brightness parameter value of pixels in the HDR image frame is determined according to the maximum brightness parameter value of the pixels in the HDR image frame and the first mapping table. Where the maximum brightness parameter value of the pixels records the maximum brightness value of the HDR image frame content, and the first mapping table records a corresponding relation between a maximum brightness parameter value of pixels and a current amplitude of the PWM control signal.

In some embodiments, the first mapping table is preset according to the image content brightness levels and the performance of the backlight source, where there is a one-to-one corresponding relation between the maximum brightness parameter values and the current amplitudes of the PWM control signal.

In some embodiments, the image content brightness of the HDR video is generally represented by the amount of information of 10 bits, that is, the range of the brightness levels is [0,1023]. It is assumed that the value range of the current amplitude of the PWM control signal of the backlight source is [1 A,5 A], then [1 A,5 A] may be divided equally into 1024 parts or divided non-uniformly into 1024 parts, which correspond to 1024 brightness levels in the range of [0,1023] respectively. Here, there is a positive correlation between the current amplitude of the PWM control signal and the brightness level, that is, the maximum brightness parameter value corresponds to the maximum current amplitude. The current amplitude of the PWM control signal is set by looking up the first mapping table, which may simplify the process of driving the backlight source and increase the efficiency of driving the backlight adjustment of the backlight source.

In some embodiments, the first mapping table is preset by considering the performance indices of the components of the backlight source, and the current amplitudes of the PWM control signal in the first table are between the minimum current amplitude and the maximum current amplitude. Where the minimum current amplitude corresponds to the minimum current value of the backlight source and the maximum current amplitude corresponds to the maximum current value of the backlight source, that is, different current amplitudes of the PWM control signal correspond respectively to different current values of the backlight source. For example, if the current amplitude of the PWM control signal is set to be the minimum current amplitude, then the current value of the backlight source is the minimum current value.

Operation S102: determining the duty ratio of the PWM control signal according to the grayscale values of the pixels of the HDR image frame.

In some embodiments, the grayscale mean value of the HDR image frame may be obtained by counting the grayscale values of all the pixels of the HDR image frame, and the grayscale mean value and the maximum grayscale value may also be determined according to the maximum brightness parameter value and the average frame brightness of the pixels in the metadata.

Then the duty ratio of the PWM control signal is equal to the ratio of the grayscale mean value of the HDR image frame to the maximum grayscale value of the HDR image frame, which may be calculated by formula (1).

$$D = \frac{{G}_{mean}}{{G}_{max}} \qquad ( 1 )$$

Where D represents the duty ratio of the PWM control signal, Gₘₑₐₙ represents the grayscale mean value of the HDR image frame, Gₘₐₓ represents the maximum grayscale value of the HDR image frame, and the value of the duty ratio is less than 1.

In some embodiments, the method for calculating the duty ratio of the PWM control signal may be improved on the basis of the above formula (1). A weight item may be set to optimize the duty ratio of the PWM control signal when calculating the duty ratio of the PWM control signal, as shown in the formula (2).

$$D = \frac{{k}_{1} * {G}_{mean} + {k}_{2} * {G}_{max}}{{G}_{max}} \qquad ( 2 )$$

Where k₁ and k₂ are weight items, and k₁+k₂=1. The duty ratio of the PWM control signal is obtained by adjusting the weight items so that the duty ratio may match with the current amplitude of the PWM control signal determined in the operation S101 to generate the PWM control signal to drive the backlight source to achieve the object brightness.

In some embodiments, the operation S101 and the operation S102 may be two independent operations and may be performed separately without limiting any order. Selecting the suitable current amplitude and duty ratio of the PWM control signal is the basis of the good drive effect of the backlight source in operation S103.

Operation S103: driving the backlight source to emit light according to the PWM control signal.

In some embodiments, if the time duration, during which a working current value of the backlight source is between the rated current value and the maximum current value of the backlight source, exceeds a threshold, the current amplitude of the PWM control signal is adjusted to be a current amplitude corresponding to the rated current value of the backlight source for the purpose of preventing the backlight source from being damaged due to operating at a current exceeding the rated current value for a long time. For example, the threshold is set to be 5 minutes, and if the time duration, during which the working current value of the backlight source is between the rated current value and the maximum current value of the backlight source, exceeds 5 minutes, then adjusting the current amplitude of the PWM control signal to be the current amplitude corresponding to the rated current value of the backlight source so that the backlight source operates at the rated current value.

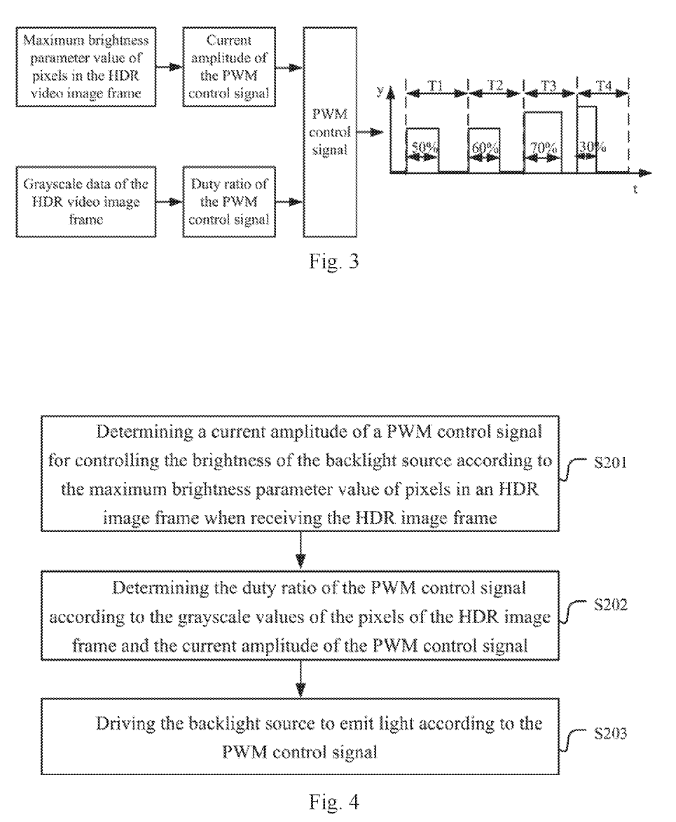

It shall be noted that the current value of the backlight source and the current amplitude of the PWM control signal are different concepts. Where, the current value of the backlight source is the current value at which the backlight source operates actually, while the PWM control signal is generally a level signal. When the low level of the PWM control signal is 0, the current amplitude of the PWM control signal is the corresponding value when the PWM control signal is at the high level, for example, see the rectangular wave in FIG. 3, where the corresponding value at the highest point of the rectangular wave is the current amplitude of the PWM control signal. When the low level of the PWM control signal is not 0, the current amplitude of the PWM control signal refers to the amplitude difference between the high-level state and the low-level state of the generated PWM control signal.

In the embodiments of the present application, when an HDR image frame is received, the maximum brightness parameter value of the pixels of the HDR image frame is determined and the current amplitude of the PWM control signal is determined according to the mapping relationship between the maximum brightness parameter value of the pixels in the HDR image frame and the current amplitude of the PWM control signal. Compared with the related backlight driving method which uses the fixed current amplitude and adjusts the current amplitude when it is determined that the backlight brightness is greater than a threshold, in the embodiments of the present application, on the one hand the operations are simple and the backlight control efficiency may be increased; and on the other hand the duty ratio of the PWM control signal is determined by the grayscale values of the HDR image frame to match up with the adjustment of the current amplitude of the PWM control signal, which may solve the problem that the backlight brightness of the scene with a small highlighted area cannot be increased by the related art and further improve the display effect of the HDR video.

FIG. 3 is a schematic diagram of a process of generating a PWM control signal in some embodiments which may correspond to the above-mentioned method for driving the backlight source in the FIG. 2. As shown in FIG. 3, the current amplitude of the PWM control signal is determined by the maximum brightness parameter value of the pixels in the HDR video image frame, the duty ratio is obtained by the grayscale data of the HDR video image frame. The PWM control signal is determined by the current amplitude of the PWM control signal and the duty ratio, to generate the rectangular wave as shown in FIG. 3, where the abscissa of the wave represents the time t and the ordinate represents the current amplitude y of the PWM control signal. The ratio of the time period during which the amplitude is not 0 in a cycle to the whole cycle represents the duty ratio of the backlight current. The backlight brightness may vary in the range of 0% to 100% of the peak brightness corresponding to the current amplitude y by adjusting the duty ratio of the PWM control signal.

Compared with the related technology where the PWM control signal uses the fixed current amplitude, the present application may break through the limitation that the fixed backlight brightness is achieved by the fixed current, so that the brightness of the backlight source may match with the pixel brightness of the video image, better adapt to the HDR image properties (e.g., large contrast ratio), and may increase the backlight brightness of the scene with a small highlighted area and improve the display effect.

Some embodiments of the present application further provide a method for driving a backlight source, which is described as follows.

Some embodiments of the present application provide another method for driving a backlight source. The flow chart of this method for driving the backlight source is as shown in FIG. 4, where the operations of the method are as follows.

Operation S201: determining a current amplitude of a PWM control signal for controlling the brightness of the backlight source according to the maximum brightness parameter value of pixels in an HDR image frame when receiving the HDR image frame.

In some embodiments, the operation S201 is similar to the operation S101 described above. Please refer to the above content and the repeated description thereof will be omitted here.

Operation S202: determining the duty ratio of the PWM control signal according to the grayscale values of the pixels in the HDR image frame and the current amplitude of the PWM control signal.

In some embodiments, the mean brightness value of the HDR image frame is determined according to the grayscale values of the pixels in the HDR image frame, as shown by the formula (3).

Y=0.299×R+0.587×G+0.114×B

U=−0.147×R−0.289×G+0.437×B

V=0.615×R−0.515×G−0.100×B (3)

Where Y represents the brightness value of a pixel in the image frame, U represents a first chroma signal of a pixel, V represents a second chroma signal of a pixel, R represents the brightness value of a red sub-pixel in the pixel, G represents the brightness value of a green sub-pixel in the pixel, and B represents the brightness value of a blue sub-pixel in the pixel.

The brightness value Y of each pixel in the image frame may be obtained according to the above formula (3), and then the brightness values of all the pixels of the HDR image frame are averaged to obtain the mean brightness value of the HDR image frame. However the backlight brightness peak of the backlight source may be determined according to the current amplitude of the PWM control signal, and the duty ratio of the PWM control signal may be obtained according to the formula (4).

$$D = f * \frac{C}{M} \qquad ( 4 )$$

Where D represents the duty ratio of the PWM control signal, f represents the mapping proportion, C represents the mean brightness value of the HDR image frame, and M represents the backlight brightness peak of the backlight source which may be determined according to the current amplitude of the PWM control signal.

Where the mapping proportion f is the ratio of the backlight brightness range of the backlight source to the brightness range of the HDR image, and generally f<1.

In some embodiments, the mean brightness value of the HDR image frame is 5000 nits, while the current amplitude of the PWM control signal is 1 A which corresponds to the backlight brightness peak of 2000 nits of the backlight source, and the brightness range of the HDR image is [0,10000] and the backlight brightness range of the backlight source is [0,2000], so f is equal to 0.2 and D is equal to 0.5, that is, the duty ratio of the PWM control signal is 0.5.

Operation S203: driving the backlight source to emit light according to the PWM control signal.

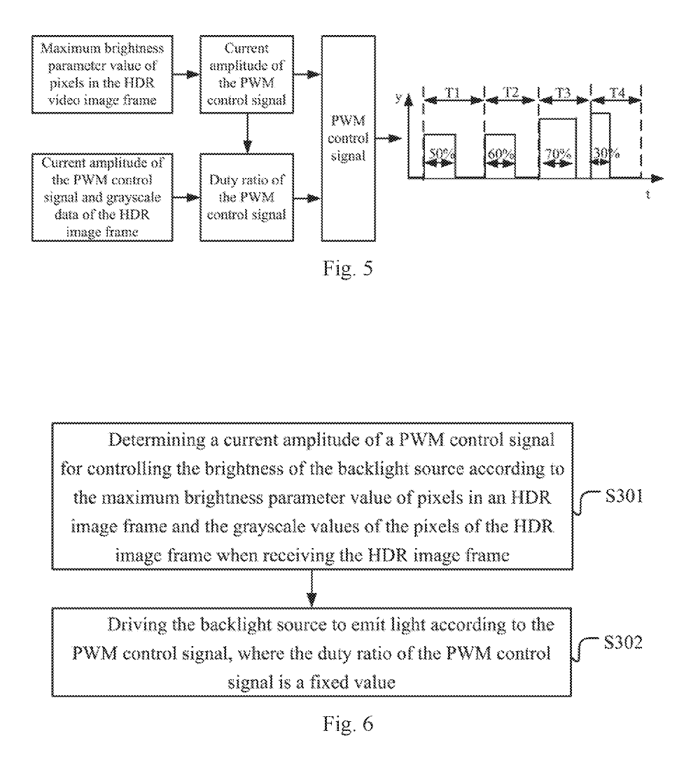

In some embodiments, the schematic diagram of the process of generating the PWM control signal corresponding to the above method for driving the backlight source in FIG. 4 may refer to FIG. 5. By comparing FIG. 5 with FIG. 3, the difference between the operations of the two methods for driving the backlight source is that the duty ratio of the PWM control signal is determined according to the grayscale data of the HDR image frame in FIG. 3, while the duty ratio of the PWM control signal is determined by the overall consideration of the current amplitude of the PWM control signal and the grayscale data of the HDR image frame in FIG. 5.

In some embodiments, the above operation S201 is performed before the operation S202 because the peak backlight brightness of the backlight source changes as the current amplitude of the PWM control signal changes. On the basis of considering this factor, the duty ratio of the control signal is computed so that the duty ratio may match adaptively with the current amplitude of the PWM control signal, thus the matching effect of the HDR image brightness and the backlight brightness may be achieved to thereby solve the problem that the backlight brightness of the scene with a small highlighted area cannot be increased by the related art.

Some embodiments of the present application further provide a method for driving a backlight source, and as shown in FIG. 6, the operations are as follows.

Operation S301: determining a current amplitude of a PWM control signal for controlling the brightness of the backlight source according to the maximum brightness parameter value of pixels in an HDR image frame and the grayscale values of the pixels of the HDR image frame when receiving the HDR image frame.

In some embodiments, the adjustment coefficient of the current amplitude may be determined according to the maximum brightness parameter value of the pixels and the grayscale values of the pixels.

In some embodiments, the grayscale values of the pixels in the HDR image frame may be counted and the weighted average calculation is performed on the grayscale values to determine the average grayscale value of the HDR image frame, so as to obtain the mean brightness value of HDR image frame. The operations of obtaining the mean brightness value of the HDR image frame may refer to the description of the above operation S202, e.g., refer to the formula (3), and the details will be omitted here.

The adjustment coefficient of the current amplitude is determined according to the mean brightness value of the HDR image frame and the maximum brightness parameter value of the pixels in the HDR image frame, which may refer to the formula (5).

$$h = \frac{{m}_{1} * {Y}_{mean} + {m}_{2} * {Y}_{max}}{{m}_{3} {Y}_{max}} \qquad ( 5 )$$

Where h represents the adjustment coefficient of the current amplitude, m₁, m₂ and m₃ represent the adjustment factors, Yₘₑₐₙ represents the mean brightness value of the HDR image frame, and Yₘₐₓ represents the maximum brightness parameter value of the pixels in the HDR image frame.

In some embodiments, the current amplitude of the PWM control signal determined according to the maximum brightness parameter value may be determined as the initial current amplitude, of which the details may refer to the above operations S101 and S202 and will be omitted here. Then the initial current amplitude is adjusted (or corrected) according to the adjustment coefficient of the current amplitude determined above, to obtain the adjusted current amplitude, and then the adjusted current amplitude is used as the current amplitude of the PWM control signal to control the driving of the backlight source.

In some embodiments, the initial current amplitude is multiplied by the adjustment coefficient of the current amplitude to obtain the current amplitude of the PWM control signal.

In some embodiments, if the current amplitude is adjusted to generate the adjusted current amplitude, the adjusted current amplitude is used as the basis of performing the subsequent operations, that is, the current amplitude in the subsequent operations may be replaced by the adjusted current amplitude.

Operation S302: driving the backlight source to emit light according to the PWM control signal, where the duty ratio of the PWM control signal is a fixed value.

In some embodiments, the duty ratio of the PWM control signal may be set to be 1.

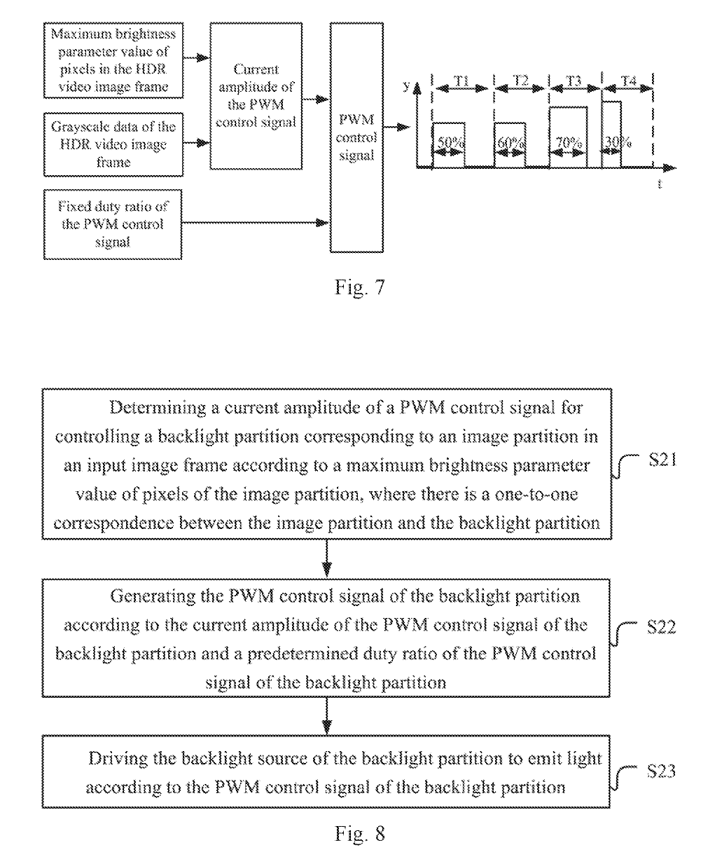

In some embodiments, the schematic diagram of the process of generating the PWM control signal corresponding to the above method for driving the backlight source in FIG. 6 may refer to FIG. 7. In the case that the duty ratio of the PWM control signal is a fixed value, the adjustment coefficient of the current amplitude is determined according to the maximum brightness parameter value of the pixels in the HDR image frame and the grayscale values of the pixels of the HDR image frame so as to adjust the current amplitude of the PWM control signal, so that the control signal drives the backlight source to achieve the backlight brightness which may match with the pixel brightness of the HDR image frame, thus it is beneficial to increase the contrast ratio of the display image and to increase the backlight brightness of the scene with a small highlighted area.

FIG. 8 is a flow chart of another method for driving a backlight source provided by some embodiments of the present application. As shown in FIG. 8, this method may be used for the partition backlight control and includes the following operations.

Operation S21: determining a current amplitude of a PWM control signal for controlling a backlight partition corresponding to an image partition in an input image frame according to a maximum brightness parameter value of pixels of the image partition, where there is a one-to-one correspondence between the image partition and the backlight partition.

In some embodiments, the input image frame may be an HDR image frame, and of course may also be the image frame in another format and is not limited by the embodiments of the present application.

In some embodiments, the backlight region may be divided into a plurality of backlight partitions in advance, while the image frame is divided into image partitions of which the number is same as that of the backlight partitions, where one backlight partition corresponds to one image partition.

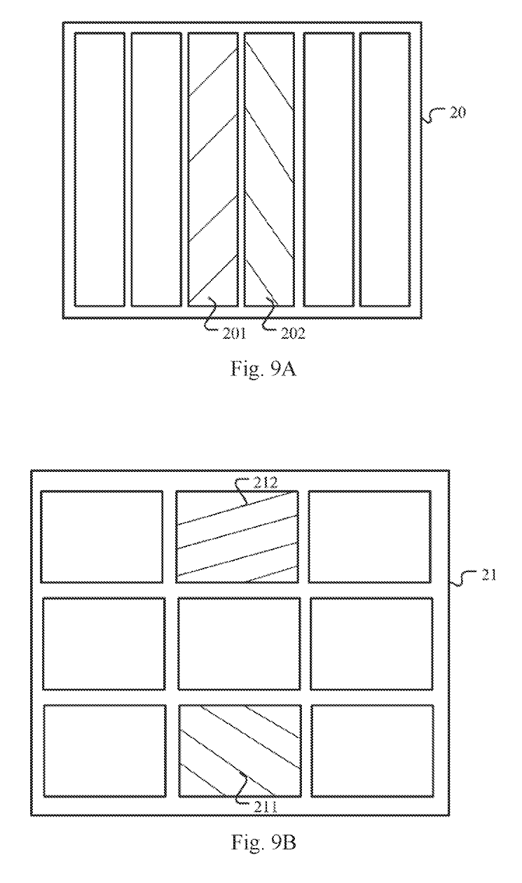

FIG. 9A and FIG. 9B list two ways for dividing a backlight region. As shown in FIG. 9A, the backlight region 20 is divided into 6 strip partitions, and as shown in FIG. 9B, the backlight region 20 is divided into 9 blocky partitions. Similarly, the uniform partition is described above, and of course, the non-uniform partition is also possible. The partition ways of the video image frame and the backlight region are not limited herein.

In some embodiments, when the current amplitude of the PWM control signal for controlling the brightness of the backlight partition corresponding to the image partition in the input image frame according to the maximum brightness parameter value of the pixels of the image partition, the following approach may be used: determining the current amplitude of the PWM control signal corresponding to the maximum brightness parameter value of the pixels according to the maximum brightness parameter value of the pixels in the image partition and a second mapping table. Where the second mapping table records a corresponding relation between a maximum brightness parameter value and a current amplitude of the PWM control signal.

The current amplitude of the PWM control signal corresponding to the backlight partition is determined by looking up the second mapping table, which may simplify the process of driving the backlight source and increase the efficiency of driving the backlight adjustment of the backlight source.

Operation S22: generating the PWM control signal of the backlight partition according to the current amplitude of the PWM control signal of the backlight partition and a predetermined duty ratio of the PWM control signal of the backlight partition.

In some embodiments, after the current amplitude of the PWM control signal for controlling the backlight partition corresponding to the image partition in the input image frame is determined according to the maximum brightness parameter value of the pixels in the image partition, the current amplitude may further be adjusted as follows.

Determining an adjustment coefficient of the current amplitude of the PWM control signal of the backlight partition according to the maximum brightness parameter value of the pixels in the image partition corresponding to the backlight partition and an average grayscale value of the pixels in the image partition corresponding to the backlight partition; and adjusting the current amplitude according to the adjustment coefficient of the current amplitude to obtain an adjusted current amplitude of the PWM control signal of the backlight partition.

If the current amplitude of the PWM control signal of the backlight partition is adjusted using the above method, then the operation S22 is performed based on the adjusted current amplitude. That is, the PWM control signal of the backlight partition is generated according to the adjusted current amplitude of the PWM control signal of the backlight partition and the predetermined duty ratio of the PWM control signal of the backlight partition.

In some embodiments, the average grayscale value of the pixels in the image partition corresponding to the backlight partition may be determined by performing the weighted average calculation on the grayscale values of the pixels in the image partition. The mean brightness value of the image partition may be obtained after the average grayscale value of the pixels in the image partition is determined. The method of calculating the average grayscale value is similar to that described in the above embodiments and a detailed description thereof will be omitted here.

The adjustment coefficient of the current amplitude may be determined according to the mean brightness value of the image partition and the maximum brightness parameter value of the pixels in the image partition, of which the details may refer to the formula (6).

$$h ’ = \frac{{{{{m ’}_{1} * Y ’}_{mean} + m ’}_{2} Y ’}_{mean}}{{{m ’}_{3} Y ’}_{max}} \qquad ( 6 )$$

Where h′ represents the adjustment coefficient of the current amplitude, m′₁, m′₂ and m′₃ represent adjustment factors, Y′ₘₑₐₙ represents the mean brightness value of the image partition, and Y′ₘₐₓ represents the maximum brightness parameter value of the pixels in the image partition.

In some embodiments, adjusting the current amplitude according to the adjustment coefficient of the current amplitude may be performed by multiplying the current amplitude by the adjustment coefficient of the current amplitude to obtain the current amplitude of the PWM control signal for controlling the brightness of the backlight partition.

In some embodiments, the predetermined duty ratio of the PWM control signal for controlling the backlight partition corresponding to the image partition is determined according to the grayscale values of the pixels in the image partition.

In some embodiments, the ratio of the grayscale mean value of the image partition to the maximum grayscale value of the image partition is used as the duty ratio of the PWM control signal for controlling the brightness of the backlight partition.

For example, FIG. 9A is taken as an example. The grayscale mean value of the backlight partition 201 is 60 and the maximum grayscale value is 100, so the duty ratio of the PWM control signal corresponding to this backlight partition, which is obtained by computing the grayscale mean value and the maximum grayscale value of the backlight partition 201, is 0.6.

In some embodiments, the duty ratio of the PWM control signal of the backlight partition may also be determined by the formula (7).

$$D ’ = \frac{{{{{k ’}_{1} * G ’}_{mean} + k ’}_{2} * G ’}_{max}}{{G ’}_{max}} \qquad ( 7 )$$

Where D′ represents the duty ratio of the PWM control signal of the backlight partition, k′₁ and k′₂ are weight items, and k′₁+k′₂=1. The duty ratio of the PWM control signal of the backlight partition is obtained by adjusting the weight items so that the duty ratio may match with the current amplitude of the PWM control signal determined in the operation S21 to generate the PWM control signal to drive the backlight source of the backlight partition to achieve the object brightness.

In some embodiments, the predetermined duty ratio of the PWM control signal for controlling the backlight partition may be determined according to the grayscale values of the pixels in the image partition corresponding to the backlight partition and the current amplitude of the PWM control signal of the backlight partition, of which the process is as follows.

Operation A: determining the mean brightness value according to the grayscale values of the pixels in the image partition corresponding to the backlight partition. The details thereof may refer to the above formula (3) by which the brightness value of each pixel in the image partition is determined. But in this case, Y in the formula (3) will represent the brightness value of each pixel in the image partition, and then the brightness values of all the pixels in the image partition are averaged to obtain the mean brightness value.

Operation B: determining the backlight brightness peak of the backlight source of the backlight partition according to the current amplitude of the PWM control signal of the backlight partition.

Operation C: determining the duty ratio of the PWM control signal of the backlight partition according to the mean brightness value of the image partition and the backlight brightness peak of the backlight source of the backlight partition, as can be seen in the formula (8).

$$D ’ = f ’ * \frac{C ’}{M ’} \qquad ( 8 )$$

Where D′ represents the duty ratio of the PWM control signal, f′ represents the mapping proportion, C′ represents the mean brightness value of the image partition, and M′ represents the backlight brightness peak of the backlight source of the backlight partition.

Where the mapping proportion f′ is the ratio of the backlight brightness range of the backlight source of the backlight partition to the brightness range of the image partition, and generally f′<1.

In some embodiments, the predetermined duty ratio of the PWM control signal for controlling the backlight partition is a preset fixed value.

In some embodiments, the predetermined duty ratio of the PWM control signal for controlling the backlight partition is 1.

Operation S23: driving the backlight source of the backlight partition to emit light according to the PWM control signal of the backlight partition.

In some embodiments, driving the backlight source to emit light according to the PWM control signal may be implemented by the following approach.

If the time duration, during which the working current value of the backlight source of the backlight partition is between a rated current value and a maximum current value of the backlight source, exceeds a threshold, when driving the backlight source of the backlight partition to emit light through the PWM control signal corresponding to the backlight partition, then adjusting the current amplitude of the PWM control signal of the backlight partition to be a current amplitude corresponding to the rated current value of the backlight source of the backlight partition.

With the above methods, the independent control of different backlight partitions may be achieved, that is, for each backlight partition, the PWM control signal for controlling the backlight partition may be determined, so that the backlight source of the backlight partition is driven to emit light according to the PWM control signal corresponding to the backlight partition.

Based on the same inventive concept, in correspondence to the methods proposed in the above-mentioned embodiments, embodiments of the present application provide devices for driving a backlight source, which correspond to the above-mentioned methods and are described as follows.

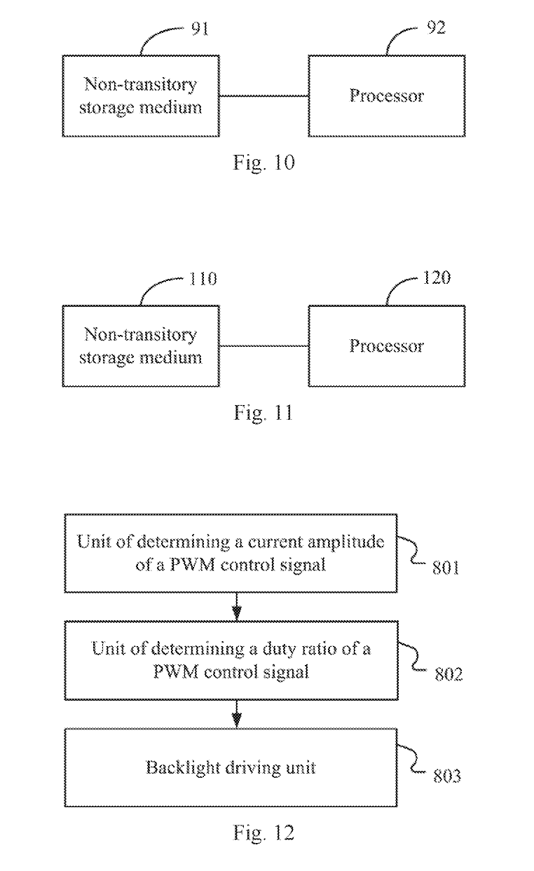

FIG. 10 is a structure block diagram of a device for driving a backlight source provided by some embodiments of the present application, which includes: a non-transitory storage medium 91 configured to store preset computer program codes; and at least one processor 92 configured to read the preset computer program codes in the non-transitory storage medium 91 to perform the operations of: determining a current amplitude of a PWM control signal for controlling a brightness of the backlight source according to a maximum brightness parameter value of pixels in an input image frame; generating the PWM generating the PWM control signal for controlling the brightness of the backlight source according to the current amplitude of the PWM control signal and a predetermined duty ratio of the PWM control signal; and driving the backlight source to emit light according to the generated PWM control signal.

Therein one processor is taken as an example to illustrate in FIG. 10.

In some embodiments, the input image frame is an HDR image frame.

In some embodiments, the at least one processor 92 is further configured to read the preset computer program codes in the non-transitory storage medium 91 to perform the operation of: determining the current amplitude of the PWM control signal corresponding to the maximum brightness parameter value of the pixels in the image frame according to the maximum brightness parameter value of the pixels in the image frame and a first mapping table.

Where the first mapping table records a corresponding relation between a maximum brightness parameter value and a current amplitude of the PWM control signal.

In some embodiments, after determining the current amplitude of the PWM control signal for controlling the brightness of the backlight source according to the maximum brightness parameter value of the pixels in the input image frame, the at least one processor 92 is further configured to read the preset computer program codes in the non-transitory storage medium 91 to perform the operations of: determining an adjustment coefficient of the current amplitude of the PWM control signal according to the maximum brightness parameter value of the pixels in the image frame and an average grayscale value of the pixels in the image frame; and adjusting the current amplitude according to the adjustment coefficient of the current amplitude to obtain an adjusted current amplitude.

The at least one processor 92 is further configured to read the preset computer program codes in the non-transitory storage medium 91 to perform the operation of: generating the PWM control signal for controlling the brightness of the backlight source according to the adjusted current amplitude of the PWM control signal and the predetermined duty ratio of the PWM control signal.

In some embodiments, the predetermined duty ratio of the PWM control signal is determined according to grayscale values of the pixels in the image frame.

In some embodiments, when the duty ratio of the PWM control signal is determined according to the grayscale values of the pixels in the image frame, it is determined by the following formula.

$$D = \frac{{G}_{mean}}{{G}_{max}}$$

Where D represents the duty ratio of the PWM control signal, Gₘₑₐₙ represents the grayscale mean value of the image frame, Gₘₐₓ represents the maximum grayscale value of the image frame, and the value of the duty ratio is less than 1.

In some embodiments, when the duty ratio of the PWM control signal is determined according to the grayscale values of the pixels in the image frame, it is determined by the following formula.

$$D = \frac{{k}_{1} * {G}_{mean} + {k}_{2} * {G}_{max}}{{G}_{max}}$$

Where D represents the duty ratio of the PWM control signal, k₁ and k₂ are the weight items, and k₁+k₂=1.

In some embodiments, the predetermined duty ratio of the PWM control signal is determined according to grayscale values of the pixels in the image frame and the current amplitude of the PWM control signal.

In some embodiments, the predetermined duty ratio of the PWM control signal is a fixed value.

In some embodiments, the at least one processor 92 is further configured to read the preset computer program codes in the non-transitory storage medium 91 to perform the operation of: if a time duration, during which a working current value of the backlight source is between a rated current value and a maximum current value of the backlight source, exceeds a threshold, then adjusting the current amplitude of the PWM control signal to be a current amplitude corresponding to the rated current value of the backlight source.

FIG. 11 is a structure block diagram of a device for driving a backlight source provided by some embodiments of the present application, which includes: a non-transitory storage medium 110 configured to store preset computer program codes; and at least one processor 120 configured to read the preset computer program codes in the non-transitory storage medium 110 to perform the operations of: determining a current amplitude of a PWM, control signal for controlling a backlight partition corresponding to an image partition in an input image frame according to a maximum brightness parameter value of pixels in the image partition, where there is a one-to-one correspondence between the image partition and the backlight partition; generating the PWM control signal of the backlight partition according to the current amplitude of the PWM control signal of the backlight partition and a predetermined duty ratio of the PWM control signal of the backlight partition; and driving the backlight source of the backlight partition to emit light according to the PWM control signal of the backlight partition.

In some embodiments, the at least one processor 120 is further configured to read the preset computer program codes in the non-transitory storage medium 110 to perform the operation of: determining the current amplitude of the PWM control signal corresponding to the maximum brightness parameter value of the pixels in the image partition according to the maximum brightness parameter value of the pixels in the image partition and a second mapping table.

Where the second mapping table records a corresponding relation between a maximum brightness parameter value and a current amplitude of the PWM control signal.

In some embodiments, after determining the current amplitude of the PWM control signal for controlling the backlight partition corresponding to the image partition in the input image frame according to the maximum brightness parameter value of the pixels in the image partition, the at least one processor 120 is further configured to read the preset computer program codes in the non-transitory storage medium 110 to perform the operations of: determining an adjustment coefficient of the current amplitude of the PWM control signal of the backlight partition according to the maximum brightness parameter value of the pixels in the image partition corresponding to the backlight partition and an average grayscale value of the pixels in the image partition corresponding to the backlight partition; and adjusting the current amplitude according to the adjustment coefficient of the current amplitude to obtain an adjusted current amplitude of the PWM control signal of the backlight partition.

The at least one processor 120 is further configured to read the preset computer program codes in the non-transitory storage medium 110 to perform the operation of: generating the PWM control signal of the backlight partition according to the adjusted current amplitude of the PWM control signal of the backlight partition and the predetermined duty ratio of the PWM control signal of the backlight partition.

In some embodiments, the predetermined duty ratio of the PWM control signal of the backlight partition is determined according to grayscale values of the pixels in the image partition corresponding to the backlight partition.

In some embodiments, the predetermined duty ratio of the PWM control signal of the backlight partition is determined according to grayscale values of the pixels in the image partition corresponding to the backlight partition and the current amplitude of the PWM control signal of the backlight partition.

In some embodiments, the predetermined duty ratio of the PWM control signal of the backlight partition is a fixed value.

In some embodiments, the at least one processor 120 is further configured to read the preset computer program codes in the non-transitory storage medium 110 to perform the operation of: if a time duration, during which a working current value of the backlight source of the backlight partition is between a rated current value and a maximum current value of the backlight source, exceeds a threshold, when driving the backlight source of the backlight partition to emit light through the PWM control signal of the backlight partition, then adjusting the current amplitude of the PWM control signal of the backlight partition to be a current amplitude corresponding to the rated current value of the backlight source of the backlight partition.

FIG. 12 is a structure schematic diagram of another device for driving a backlight source provided by some embodiments of the present application. As shown in FIG. 12, this device includes: a unit of determining a current amplitude of a PWM control signal 801 configured to determine the current amplitude of the PWM control signal for controlling the brightness of the backlight source according to the maximum brightness parameter value of pixels in an HDR image frame when receiving the HDR image frame.

In some embodiments, to determine the current amplitude of the PWM control signal corresponding to the maximum brightness parameter value of the HDR image frame content according to the maximum brightness parameter value of the pixels in the HDR image frame and a first mapping table. Where the maximum brightness parameter value records the maximum brightness parameter value of the HDR image frame content, and the first mapping table records a corresponding relation between a maximum brightness parameter value of pixels and a current amplitude of the PWM control signal.

In some embodiments, if the time duration, during which a working current value of the backlight source is between a rated current value and a maximum current value of the backlight source, exceeds a threshold, adjusting the current amplitude of the PWM control signal to be a current amplitude corresponding to the rated current value of the backlight source.

The device also includes: a unit of determining a duty ratio of a PWM control signal 802 configured to determine the duty ratio of the PWM control signal according to the grayscale values of the pixels of the HDR image frame; and a backlight driving unit 803 configured to drive the backlight source to emit light according to the PWM control signal.

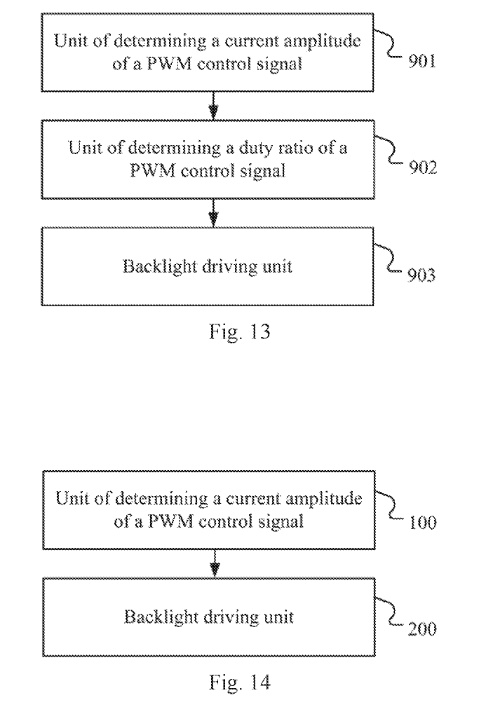

FIG. 13 is a structure schematic diagram of another device for driving a backlight source provided by some embodiments of the present application. As shown in FIG. 13, this device includes: a unit of determining a current amplitude of a PWM control signal 901 configured to determine the current amplitude of the PWM control signal for controlling the brightness of the backlight source according to the maximum brightness parameter value of pixels in an HDR image frame when receiving the HDR image frame; a unit of determining a duty ratio of a PWM control signal 902 configured to determine the duty ratio of the PWM control signal according to the grayscale values of the pixels of the HDR image frame and the current amplitude of the PWM control signal; and a backlight driving unit 903 configured to drive the backlight source to emit light according to the PWM control signal.

FIG. 14 is a structure schematic diagram of another device for driving a backlight source provided by some embodiments of the present application. As shown in FIG. 14, this device includes: a unit of determining a current amplitude of a PWM control signal 100 configured to determine the current amplitude of the PWM control signal for controlling the brightness of the backlight source according to the maximum brightness parameter value of pixels in an HDR image frame and the grayscale values of the pixels of the HDR image frame when receiving the HDR image frame; and a backlight driving unit 200 configured to drive the backlight source to emit light according to the PWM control signal, where the duty ratio of the PWM control signal is a fixed value.

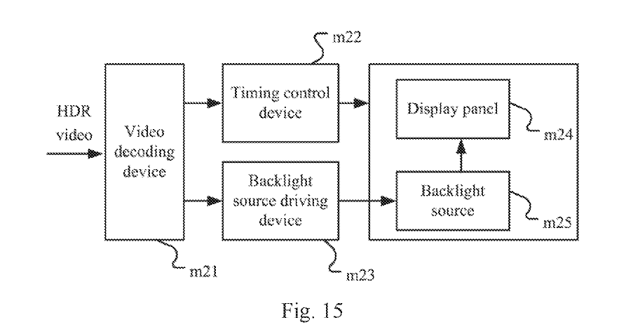

FIG. 15 is a structure diagram of a liquid crystal display terminal provided by some embodiments of the present application. As shown in FIG. 15, this terminal includes: a video decoding device m21, which is connected to a timing control device m22 and a backlight source driving device m23, and by which the video may obtain the grayscale data, the metadata and the like of the HDR video image frame.

The timing control device m22, which is connected to a display panel m24 and may input an output signal in the timing control device to the display panel m24 through a connector to control the synchronous display of the image and the audio. Where the output signal may include a differential data signal, a line field scan signal, a liquid crystal panel digital voltage, a liquid crystal panel analog voltage, a liquid crystal panel VGH voltage, a liquid crystal panel GAMMA voltage, a liquid crystal panel VGL voltage, a liquid crystal panel VCOM voltage, and an auxiliary voltage and the like.

The backlight source driving device m23 is connected to a backlight source m25. The display effect of the HDR video image may be improved by the backlight source driving device, of which the operations and functions have been introduced in details in the above-mentioned embodiments and will be omitted here.

The backlight source m25 is connected to the display panel m24 and the display panel displays images via the light emitted by the backlight source. The backlight source may include a backlight source in form of direct-type light incidence and a backlight source in form of side-type light incidence, where the backlight source in form of direct-type light incidence provides a plurality of grid-type region backlight source units, each of the backlight source units provides its mapping region with the light source, and the backlight source in form of side-type light incidence is arranged on the side of the liquid crystal display panel and may be for example an LED.

The display panel m24 includes a plurality of display regions, each of which includes a plurality of display pixels, and each display pixel includes a red pixel unit R, a green pixel unit G and a blue pixel unit B. For example, the 1080P liquid crystal display screen includes 1080*1920 pixels, each of which includes three pixel units R, G and B, and thus there are totally 1080*1920*3 pixel units and the liquid crystal display screen may be divided into 20 display regions.

As can be understood clearly by those skilled in the art, for the convenience and simplicity of description, the working processes of the above-mentioned devices and units may refer to the mapping processes in the method embodiments described above and will be omitted here.

In some embodiments, the above-mentioned liquid crystal display terminal may further includes a non-transitory storage medium and at least one processor, where the non-transitory storage medium stores preset computer program codes, and the at least one processor is configured to read the preset computer program codes in the non-transitory storage medium to perform the operations in any method embodiment described above and will be omitted here.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for driving a backlight source, the method comprising:
determining a current amplitude of a Pulse Width Modulation (PWM) control signal for controlling a brightness of the backlight source according to a maximum brightness parameter value of pixels in an input image frame;
generating the PWM control signal for controlling the brightness of the backlight source according to the current amplitude of the PWM control signal and a predetermined duty ratio of the PWM control signal; and
driving the backlight source according to the generated PWM control signal.

2. The method according to claim 1, wherein the determining the current amplitude of the PWM control signal for controlling the brightness of the backlight source according to the maximum brightness parameter value of the pixels in the input image frame comprises:
determining the current amplitude of the PWM control signal corresponding to the maximum brightness parameter value of the pixels in the image frame according to the maximum brightness parameter value of the pixels in the image frame and a first mapping table;
wherein the first mapping table records a corresponding relation between a maximum brightness parameter value of pixels and a current amplitude of the PWM control signal.

3. The method according to claim 1, after determining the current amplitude of the PWM control signal for controlling the brightness of the backlight source according to the maximum brightness parameter value of the pixels in the input image frame, the method further comprises:
determining an adjustment coefficient of the current amplitude of the PWM control signal according to the maximum brightness parameter value of the pixels in the image frame and an average grayscale value of the pixels in the image frame; and
adjusting the current amplitude according to the adjustment coefficient of the current amplitude to obtain an adjusted current amplitude;
wherein the generating the PWM control signal for controlling the brightness of the backlight source according to the current amplitude of the PWM control signal and the predetermined duty ratio of the PWM control signal comprises:
generating the PWM control signal for controlling the brightness of the backlight source according to the adjusted current amplitude of the PWM control signal and the predetermined duty ratio of the PWM control signal.

4. The method according to claim 1, wherein the predetermined duty ratio of the PWM control signal is determined according to grayscale values of the pixels in the image frame.

5. The method according to claim 1, wherein the predetermined duty ratio of the PWM control signal is determined according to grayscale values of the pixels in the image frame and the current amplitude of the PWM control signal.

6. The method according to claim 1, wherein the predetermined duty ratio of the PWM control signal is a fixed value.

7. The method according to claim 1, wherein the driving the backlight source according to the PWM control signal comprises:
if a time duration, during which a working current value of the backlight source is between a rated current value and a maximum current value of the backlight source, exceeds a threshold, then adjusting the current amplitude of the PWM control signal to be a current amplitude corresponding to the rated current value of the backlight source.

8. The method according to claim 1, wherein the image frame is a High-Dynamic Range (HDR) image frame.

9. A method for driving a backlight source, wherein the method comprising:
determining a current amplitude of a Pulse Width Modulation (PWM) control signal for controlling a backlight partition corresponding to an image partition in an input image frame according to a maximum brightness parameter value of pixels in the image partition, wherein there is a one-to-one correspondence between the image partition and the backlight partition;
generating the PWM control signal of the backlight partition according to the current amplitude of the PWM control signal of the backlight partition and a predetermined duty ratio of the PWM control signal of the backlight partition; and
driving a backlight source of the backlight partition according to the PWM control signal of the backlight partition.

10. The method according to claim 9, wherein the determining the current amplitude of the PWM control signal for controlling the backlight partition corresponding to the image partition in the input image frame according to the maximum brightness parameter value of the pixels in the image partition, comprises:
determining the current amplitude of the PWM control signal corresponding to the maximum brightness parameter value of the pixels in the image partition according to the maximum brightness parameter value of the pixels in the image partition and a second mapping table;
wherein the second mapping table records a corresponding relation between a maximum brightness parameter value of pixels and a current amplitude of the PWM control signal.

11. The method according to claim 9, wherein after determining the current amplitude of the PWM control signal for controlling the backlight partition corresponding to the image partition in the input image frame according to the maximum brightness parameter value of the pixels of the image partition, the method further comprises:
determining an adjustment coefficient of the current amplitude of the PWM control signal of the backlight partition according to the maximum brightness parameter value of the pixels of the image partition corresponding to the backlight partition and an average grayscale value of the pixels of the image partition corresponding to the backlight partition; and
adjusting the current amplitude according to the adjustment coefficient of the current amplitude to obtain an adjusted current amplitude of the PWM control signal of the backlight partition;
wherein the generating the PWM control signal of the backlight partition according to the current amplitude of the PWM control signal of the backlight partition and the predetermined duty ratio of the PWM control signal of the backlight partition, comprises:
generating the PWM control signal of the backlight partition according to the adjusted current amplitude of the PWM control signal of the backlight partition and the predetermined duty ratio of the PWM control signal of the backlight partition.

12. The method according to claim 9, wherein the predetermined duty ratio of the PWM control signal of the backlight partition is determined according to grayscale values of the pixels of the image partition corresponding to the backlight partition; or
the predetermined duty ratio of the PWM control signal of the backlight partition is determined according to grayscale values of the pixels of the image partition corresponding to the backlight partition and the current amplitude of the PWM control signal of the backlight partition; or
the predetermined duty ratio of the PWM control signal of the backlight partition is a fixed value.

13. The method according to claim 9, wherein the driving the backlight source of the backlight partition according to the PWM control signal of the backlight partition comprises:
if a time duration, during which a working current value of the backlight source of the backlight partition is between a rated current value and a maximum current value of the backlight source, exceeds a threshold, then adjusting the current amplitude of the PWM control signal of the backlight partition to be a current amplitude corresponding to the rated current value of the backlight source of the backlight partition.

14. The method according to claim 9, wherein the image frame is a High-Dynamic Range (HDR) image frame.

15. A liquid crystal display terminal, comprising a backlight source and a display panel, wherein the terminal further comprises a non-transitory storage medium and at least one processor; the non-transitory storage medium stores preset computer program codes, and the processor is configured to read the preset computer program codes in the non-transitory storage medium to perform:
determining a current amplitude of a Pulse Width Modulation (PWM) control signal for controlling a brightness of the backlight source according to a maximum brightness parameter value of pixels in an input image frame;
generating the PWM control signal for controlling the brightness of the backlight source according to the current amplitude of the PWM control signal and a predetermined duty ratio of the PWM control signal; and
driving the backlight source according to the generated PWM control signal.

16. The liquid crystal display terminal according to claim 15, wherein the at least one processor is further configured to read the preset computer program codes in the non-transitory storage medium to perform:
determining the current amplitude of the PWM control signal corresponding to the maximum brightness parameter value of the pixels in the image frame according to the maximum brightness parameter value of the pixels in the image frame and a first mapping table;
wherein the first mapping table records a corresponding relation between a maximum brightness parameter value of the pixels and a current amplitude of the PWM control signal.

17. The liquid crystal display terminal according to claim 15, wherein the at least one processor is further configured to read the preset computer program codes in the non-transitory storage medium to perform:
determining an adjustment coefficient of the current amplitude of the PWM control signal according to the maximum brightness parameter value of the pixels in the image frame and an average grayscale value of the pixels in the image frame; and
adjusting the current amplitude according to the adjustment coefficient of the current amplitude to obtain an adjusted current amplitude;
wherein the at least one processor is further configured to read the preset computer program codes in the non-transitory storage medium to perform:
generating the PWM control signal for controlling the brightness of the backlight source according to the adjusted current amplitude of the PWM control signal and the predetermined duty ratio of the PWM control signal.

18. The liquid crystal display terminal according to claim 15, wherein the predetermined duty ratio of the PWM control signal is determined according to grayscale values of the pixels in the image frame; or
the predetermined duty ratio of the PWM control signal is determined according to grayscale values of the pixels in the image frame and the current amplitude of the PWM control signal; or
the predetermined duty ratio of the PWM control signal is a fixed value.

19. The liquid crystal display terminal according to claim 15, wherein the at least one processor is further configured to read the preset computer program codes in the non-transitory storage medium to perform:
if a time duration, during which a working current value of the backlight source is between a rated current value and a maximum current value of the backlight source, exceeds a threshold, adjusting the current amplitude of the PWM control signal to be a current amplitude corresponding to the rated current value of the backlight source.

20. The liquid crystal display terminal according to claim 15, wherein the image frame is a High-Dynamic Range (HDR) image frame.
